(19) United States
(12) Patent Application Publication
(10) Pub. No.: US 2020/0056088 A1
(43) Pub. Date: Feb. 20, 2020

(54) SURFACTANT PRODUCT, MANUFACTURING METHOD AND USE THEREOF IN OIL AND GAS WELL OPERATIONS

(71) Applicant: VELDMAN CONSULTING CORPORATION, Houston, TX (US)

(72) Inventor: RAYNARD VELDMAN, Bellaire, TX (US)

(21) Appl. No.: 16/543,425

(22) Filed: Aug. 16, 2019

Related U.S. Application Data
(60) Provisional application No. 62/719,678, filed on Aug. 19, 2018.

(51) Int. Cl. C09K 8/584

(52) U.S. Cl. CPC C09K 8/584; B01J 20/3085

(57) ABSTRACT

The application is directed to treating wells and subterranean formations in oil and gas well operations using surfactants. Solid treatment particles may be produced comprising one or more solid adsorbent materials and one or more surfactants adsorbed on the one or more solid adsorbent materials. The solid treatment particles are operationally configured to be introduced into wells and/or subterranean formations to carry out one or more treatments in various aspects of a life cycle of oil wells and gas wells.

### CROSS-REFERENCE TO RELATED APPLICATIONS

This application claims the benefit of U.S. provisional patent application Ser. No. 62/719,678, filed on Aug. 19, 2018, which is herein incorporated by reference.

### STATEMENT REGARDING FEDERALLY SPONSORED RESEARCH OR DEVELOPMENT

Not applicable.

### BACKGROUND OF THE APPLICATION

### 1. Field of the Invention

The application relates to solid particles comprising one or more surfactants, the method of manufacturing and using the same in oil and/or gas well completion, well construction and production operations.

### 2. Background Art

In conventional oil and gas well operations, surfactants function to reduce surface and interfacial tensions between oil and water in subterranean formations (or “producing formations”), change wettability of formation rock, eliminate downhole and surface emulsions of oil and water, and facilitate flow in the fractures. The surfactants used are typically diluted with water or water plus a winterizing agent such as methanol or glycol. Mutual solvents are also often added to facilitate dilution with water. Known liquid surfactants will typically have critical micelle values in the ppm range so dilutions to single percentages remain functional. A typical surfactant concentration will be 5.0 to 20.0% in water or in water plus winterizing agent or mutual solvent.

To reduce costs as well as the overall footprint at a well site, an alternative surfactant product is desired.

### SUMMARY

The present application is directed to a method for treating a well penetrating a subterranean formation, comprising introducing into the well free flowing solid treatment particles comprising one or more solid adsorbent materials and one or more concentrated surfactants adsorbed on the one or more solid adsorbent materials.

The present application is also directed to a method to enhance hydrocarbon recovery from a subterranean formation, the method comprising introducing into the well solid treatment particles comprising one or more solid adsorbent materials and one or more surfactants adsorbed on the one or more solid adsorbent materials.

The present application is also directed to a method for making free flowing solid treatment particles to be mixed with one or more fluids and directed into subterranean formations and used to carry out one or more subterranean treatments in various aspects of a life cycle of oil wells and gas wells, comprising (1) providing a first amount of one or more solid adsorbent materials and a second amount of one or more surfactants; and (2) contacting the one or more solid adsorbent materials with the one or more surfactants to produce solid particles comprising the one or more solid adsorbent materials and the one or more surfactants adsorbed on the one or more solid adsorbent materials.

### BRIEF DESCRIPTION OF THE SEVERAL VIEWS OF THE DRAWING

FIG. 1 is a simplified illustration of a spraying system of this application.

FIG. 2 is another simplified illustration of a spraying system of this application.

FIG. 3 is another simplified illustration of a spraying system of this application.

FIG. 4 is another simplified illustration of a spraying system of this application.

FIG. 5 is another simplified illustration of a spraying system of this application.

FIG. 6 is an illustration of an exemplary spray nozzle of this application.

FIG. 7 is an illustration of an exemplary spray nozzle of this application.

FIG. 8 is an illustration of exemplary spray nozzles of this application.

### DETAILED DESCRIPTION

Methods and compositions for use in various aspects of the life-cycle of an oil and/or gas well are provided herein. Before describing the invention in detail, it is to be understood that the present invention is not limited to particular embodiments. It is understood that no limitation of the scope of the claimed subject matter is intended by way of the disclosure. As understood by one skilled in the art to which the present disclosure relates, various changes and modifications of the principles as described and illustrated are herein contemplated. It is to be understood that the following definitions are provided in order to aid those skilled in the art in understanding the detailed description of the present invention.

Terms and phrases used in this document, and variations thereof, unless otherwise expressly stated, should be construed as open-ended as opposed to limiting. As used herein, the terms “first,” “second,” and the like do not denote any order or importance, but rather are used to distinguish one element from another, and the terms “the”, “a” and “an” do not denote a limitation of quantity, but rather denote the presence of at least one of the referenced item. The term “about” as used herein can allow for a degree of variability in a value or range, for example, within 10%, within 5%, or within 1% of a stated value or of a stated limit of a range. All numeric values are herein assumed to be modified by the term “about” whether or not explicitly indicated. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

As examples of the foregoing: the term “including” should be read as meaning “including, without limitation” or the like, the term “example” is used to provide exemplary instances of the item in discussion, not an exhaustive or limiting list thereof. The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range such as from 1 to 6 should be considered to have specifically disclosed sub-ranges such as from 1 to 3, from 2 to 4, from 3 to 6 etc., as well as individual numbers within that range, for example, 1, 2, 3, 4, 5, and 6—this applies regardless of the breadth of the range. Also disclosed herein are any and all ratios (and ranges of any such ratios) that can be formed by dividing a recited numeric value into any other recited numeric value. Accordingly, the skilled person will appreciate that many such ratios, ranges, and ranges of ratios can be unambiguously derived from the numerical values presented herein and in all instances such ratios, ranges, and ranges of ratios represent various embodiments of the present invention.

Herein, the term “surfactant” refers to a soluble, or partially soluble compound. that reduces the surface tension of liquids, or reduces inter-facial tension between two liquids, or a liquid and a solid by congregating and orienting itself at these interfaces. The term “amphoteric” refers to surfactants that have both positive and negative charges. The net charge of the surfactant can be positive, negative, or neutral, depending on the pH of the solution. The term “anionic” refers to those surfactants that possess a net negative charge. The term “viscoelastic” refers to those viscous fluids having elastic properties, i.e., the liquid at least partially returns to its original form when an applied stress is released. The phrase “viscoelastic surfactants” or “VES” refers to that class of compounds which can form micelles (spherulitic, anisometric, lamellar, or liquid crystal) in the presence of counter ions in aqueous solutions, thereby imparting viscosity to the fluid. The abbreviation “VAS” refers to a Viscoelastic Anionic Surfactant, known in the art of oil and gas hydraulic fracturing operations and frac packing.

The m “treatment” or “treating” and like terms may include, but are not necessarily limited to subterranean operations that use a fluid in conjunction with a desired function and/or for a desired purpose. The term “treatment” or “treating” and like terms do not imply any particular action by the fluid. The terms “fracturing operation,” “fracturing,” “Tracking” and “fra.c treatment” each refer to the process and methods of breaking down a geological formation and creating a fracture, i.e. the rock formation around a wellbore, by pumping fluid at very high pressures (pressure above the determined closure pressure of the formation), in order to increase production rates from a hydrocarbon reservoir. The fracturing methods otherwise use conventional techniques known in the art.

The term “drilling fluid(s)” refers to any fluid that is used during well drilling operations including oil and/or gas wells, geo-thermal wells, water wells or other similar wells. The term “completion fluid(s)” refers to any fluid that is used in oil and/or gas well completion operations. The term “production fluid(s)” refers to any fluid that is used in oil and/or gas well production operations.

As used herein and unless otherwise specified, particle size and particle size distribution (“PSD”) refer to the median volume averaged size. The median size used herein may be any value understood in the art. in certain embodiments, the median size may be a characteristic dimension, which may be a dimension considered most descriptive of the particles for specifying a size distribution range.

The term “solid” is used in its ordinary sense and refers to a state of matter of a material having a definite shape and volume wherein the material is non-Towable such that it will substantially maintain its shape without external support. As understood by the skilled artisan, “solid” materials may have a degree of resilience, bendability or deformability and yet maintain their characteristic as being a “solid.” The terms “proppant” and “proppant material” includes particulate materials used to hold fractures open, e.g., to maintain a fracture in a propped condition, in well stimulation operations. Proppant particle substrates may include, but are not necessarily limited to conventional frac sand (silica), gravel, manmade ceramics such as sintered bauxite, aluminum oxide and zirconium oxide, synthetic proppants (i.e. proppants made from synthetic resins) and metallic proppants. Naturally occurring proppants made from nut shells and fruit pits, for example, are also contemplated for use. The term “industrial sand” refers to high purity silica sand products with closely controlled sizing compared to common concrete and asphalt gravels. The term “atomization” refers to the process of breaking up bulk liquids into droplets. The term “emulsion” refers to a mixture of two mutually immiscible liquids wherein one liquid is dispersed as droplets in the other liquid and stabilized by an emulsifying agent. In conventional oil and gas well operations, water-in-oil emulsions are generally formed, although oil-in-water emulsions may also be formed. As understood by the skilled artisan, an emulsion is a two-phase system wherein the phase that is present in the form of droplets is the dispersed or internal phase, and the phase in which the droplets are suspended is called the continuous or external phase. The term “water cut” refers to the ratio of water produced to the total crude oil or gas produced during production. The term “wettability” refers to the tendency of a fluid to adhere to a solid surface in the presence of other immiscible fluids.

In the methods described herein, the steps may be carried out in any order, except when a temporal or operational sequence is explicitly recited. Furthermore, specified steps may be carried out concurrently unless explicit claim language recites that they be carried out separately.

In one aspect, the present application is directed to a method of spraying one or more treatment agents such as one or more concentrated surfactants onto solid adsorbent materials such as sand amorphous silica or other high surface area solid adsorbent materials (1) in vessels such as silos and/or (2) at mines and/or (3) during transloading and/or (4) at a well site or other location. The method may further include mixing one or more concentrated surfactants with dust control chemicals prior to the spraying step.

In another aspect, the present application is directed to free flowing solid particles or “solid treatment particles” as described herein for use in oil and/or gas well completions, well construction and production operations as well as agricultural and construction operations.

In another aspect, the present application is directed to free flowing solid treatment particles to be mixed with one or more fluids and directed into subterranean formations and used to carry out a variety of subterranean treatments in various aspects of the life cycle of an oil and/or gas well, including, but not necessarily limited to as cleaners, demulsifiers, non-emulsifiers, microemulsions, flow aids, scale control, clay stabilization, biocides, and combinations thereof. Various aspects of a well life cycle are described in detail in U.S. Pat. No. 10,000,693, tided “Methods and Compositions for Use in Oil and/or Gas Wells,” issued Jun. 19, 2018, which is herein incorporated by reference in its entirety.

In another aspect, the present application is directed to using free flowing solid treatment particles as cleaners, demulsifiers, non-emulsifiers, microemulsions, friction reducers, flow aids, scale controllers, scale inhibitors, clay stabilizers, biocides, corrosion inhibitors, paraffin inhibitors, and combinations thereof in various aspects of the life cycle of a well.

In another aspect, the application provides employing free flowing solid treatment particles comprising one or more surfactants as clay stabilizers and/or biocides and/or scale inhibitors.

In another aspect, the application provides mixing sand with free flowing solid treatment particles comprising dry surfactants including, but not necessarily limited to dry concentrated surfactants, on high surface area silica.

In another aspect, the application provides directly adding one or more concentrated liquid surfactant and a solid adsorbent into a blender or mixer for producing free flowing solid treatment particles.

In another aspect, the application provides encapsulating one or more dry surfactants including, but not necessarily limited to one or more dry concentrated surfactants in a slow dissolving polymer stick for direct injection downhole into a producing or production well to facilitate breaking of oil and water emulsions downhole and at the surface of a well.

In another aspect, the application provides adding one or more dry surfactants including, but not necessarily limited to one or more dry concentrated surfactants to a spacer fluid or slurry to clean a casing prior to cementing a well.

In another aspect, the application provides adding one or more dry surfactants including, but not necessarily limited to one or more dry concentrated surfactants to a pill or slurry for cleaning a well, gathering system or pipeline.

In another aspect, the application provides a product comprised of free flowing treatment particles including one or more active agents operationally configured to release from the treatment particle in a liquid phase to stimulate a well by being introduced into a subterranean formation or into the wellbore penetrating the subterranean formation.

In another aspect, the application provides a well stimulation fluid comprising free flowing solid treatment particles comprised of surfactants adsorbed on low surface area silicas, high surface area amorphous silicas, other high surface area solid adsorbent materials, and combinations thereof. As understood by the skilled artisan, the well stimulation fluid may include fresh water or brine, biocides, clay control additives, corrosion inhibitors, crosslinkers, gels, gel breakers, oxygen scavengers, pH buffers, proppants, and combinations thereof.

In another aspect, the application provides a method for extracting oil and/or gas from a subterranean stratum including injecting into the subterranean stratum free flowing solid treatment particles comprising one or more solid adsorbent materials and one or more surfactants adsorbed on the surface (or “contact surface”) of the one or more solid adsorbent materials; and extracting the oil and/or gas from the subterranean stratum.

In another aspect, the application provides a method comprising injecting free flowing solid treatment particles comprising one or more solid adsorbent materials and one or more surfactants adsorbed on the surface of the one or more solid adsorbent materials into a production well, wherein the one or more surfactants are operationally configured to increase an oil-to-water ratio of oil recovery from a porous matrix portion of a reservoir.

In another aspect, the application provides a method for combining solid adsorbent materials and one or more surfactants to form solid treatment particles that are flowable in liquids.

In another aspect, the present invention is directed to free flowing solid treatment particles and their production, the solid treatment particles comprising (1) a first component of one or more solid adsorbent materials and at least (2) a second component of one or more treatment agents adsorbed on the surface of the one or more solid adsorbent materials. Suitable solid adsorbent materials may include low surface area silicas, high surface area amorphous silicas, other high surface area solid adsorbent materials, and combinations thereof. Suitable treatment agents may include one or more concentrated surfactants effective to release from the surface of the one or more solid adsorbent materials when added to an aqueous liquid phase to act in a similar manner as liquid surfactants used in oil and gas well operations at the time of this application. A solid treatment particle of this application may comprise about 40.0 percent to about 70.0 percent active surfactant. In one non-limiting example, a solid treatment particle having a surface area greater than 100.0 square meters per gram of solid adsorbent materials may comprise about 40.0 percent to about 70.0 percent active surfactant. One particularly advantageous feature of the free flowing solid treatment particles of this application is that one or more surfactants may be transported or otherwise shipped as a dry product to one or more target locations for purposes of oil and gas well completion, well construction and production operations without having to transport any liquid surfactant to the one or more target locations for operational purposes. By eliminating the transport of liquid surfactant, the total weight of surfactant transport may be reduced as much as eighty-five percent (85.0%) compared to a typical liquid surfactant transport.

In another aspect, the application is directed to a gas and oil well solid treatment particle comprising (1) a solid adsorbent material defined by a first surface; and (2) one or more treatment agents adsorbed on the first surface of target solid adsorbents. In one embodiment, one or more treatment agents may include one or more surfactants. In another embodiment, the one or more treatment agents are operable to release from the surface of the solid adsorbent material when the solid treatment particle is added to an aqueous liquid phase. In one exemplary embodiment, the solid adsorbent material may include frac sand, proppant, and combinations thereof. In another aspect, the application may be directed to making the above described solid treatment particle, the method comprising (1) providing a plurality of solid adsorbent materials and a volume of one or more surfactants; and (2) spraying a volume of one or more surfactants onto the plurality of solid adsorbent materials.

In another aspect, the application is directed to a gas and oil well solid treatment particle product comprising an amount of solid particles, each solid particle having a first component including a solid adsorbent material and a second component including one or more treatment agents adsorbed on each solid adsorbent material. In one exemplary embodiment, the solid adsorbent material may include frac sand, proppant, and combinations thereof.

In another aspect, the solid treatment particles of this application provide a novel surfactant product and delivery system effective for use in oil and gas well completion, well construction and production operations, the solid treatment particles comprising one or more solid adsorbent materials and one or more treatment agents. In addition, the present application provides a technique for using an effective amount of surfactant in a form that reduces the total cost of surfactant per operation compared to known liquid surfactant operations.

The present application is also directed to a method of replacing liquid surfactant usage with a treatment product comprising (1) a solid adsorbent material defined by a first surface; and (2) one or more concentrated surfactants adsorbed on the first surface of the solid adsorbent material, wherein total surfactant usage may be reduced by as much as eighty-five percent (85.0%) compared to total liquid surfactant usage for the same oil and gas well stimulation operation.

In another aspect, the application is directed to a gas and oil well solid treatment particle comprising (I) a first component of one or more solid adsorbent materials and at least (2) a second component of one or more treatment agents adsorbed on the surface of the one or more solid adsorbent materials. In one embodiment where the second component includes liquid surfactants and where the solid treatment particles of this application are manufactured at one location and delivered to one or more second locations, the manufacture of the solid treatment particles illuminates the need for liquid storage containers that otherwise are required to transport liquid surfactants to one or more second locations.

In another aspect, the present application is directed to a method for combining free flowing solid adsorbent materials with one or more fluids to form novel solid treatment particles. The solid treatment particles may be directed into subterranean formations or into wellbores penetrating a subterranean formation to carry out one or more of a variety of subterranean treatments in various aspects of the life cycle of an oil and/or gas well. Exemplary treatments include, but are not necessarily limited to reducing or eliminating downhole emulsions, improving oil recovery, changing reservoir wetting to increase hydrocarbon flow, reducing water cut, and combinations thereof.

In another aspect, the present application is directed to a dry flowable product including one or more solid adsorbent materials and one or more surfactants adsorbed on the surface of the one or more solid adsorbent materials for use in one or more subterranean treatments in various aspects of the life cycle of an oil and/or gas well.

In another aspect, the present application is directed to a dry flowable solid treatment particle product including one or more solid adsorbent materials and one or more surfactants adsorbed on the surface of the one or more solid adsorbent materials for use as a non-emulsifier to reduce the emulsion tendency of fluids with residual oils in a subterranean formation and/or to speed up the separation of water and oil from initial well flow-back fluid for various pH conditions. As understood by persons of ordinary skill in the art, an emulsion can block fractures causing formation damage. The dry flowable solid treatment particle product of this application is operationally configured to improve production, i.e., improve oil and/or gas recovery from a well.

In another aspect, the present application is directed to a dry flowable solid treatment particle product including one or more solid adsorbent materials and one or more surfactants adsorbed on the surface of the one or more solid adsorbent materials operationally configured to alter reservoir wetting for purposes of increasing hydrocarbon flow, to reduce water cut, and combinations thereof.

In another aspect, the present application is directed to a product including one or more dry free flowing solid treatment particles comprising one or more solid adsorbent materials and one or more concentrated surfactants adsorbed on the surface of the one or more solid adsorbent materials operationally configured as a replacement for liquid surfactants being used in oil and gas well operations as of the date of this application. In one embodiment, the present application provides a method of delivering an effective amount of one or more surfactants into a subterranean formation or into the wellbore penetrating the subterranean formation for operating purposes including, but not necessarily limited to as a well cleaner, demulsifier, non-emulsifier, microemulsion, flow aid, for scale control, for clay stabilization, as a biocide, and combinations thereof. In one particular implementation for hydraulic fracturing purposes, the one or more concentrated surfactants of a solid treatment particle product may be operationally configured to enhance or increase hydrocarbon recovery when acting as a non-emulsifier, as a wetting agent in a reservoir, and combinations thereof. In fracture acidizing operations, the one or more concentrated surfactants of a solid treatment particle product may he operationally configured to enhance or increase hydrocarbon recovery when acting as a non-emulsifier, as a wetting agent in a reservoir, as an iron controller, as an acid corrosion inhibitor, as an antisludge agent, and combinations thereof. In gravel pack operations, the solid treatment particles may be directed into a well whereby the one or more concentrated surfactants of the solid treatment particles are operationally configured to enhance or increase hydrocarbon flow when acting as a non-emulsifier, as a wetting agent of the gravel pack, as a scale inhibitor as a biocide, and combinations thereof. A discussion of gravel packs is described in U.S. Pat. No. 8,662,172, titled “Methods to Gravel Pack a Well Using Expanding Materials,” issued Mar. 4, 2014, which is herein incorporated by reference in its entirety.

In another aspect, the present application is directed to a product including one or more dry free flowing solid treatment particles comprising one or more solid adsorbent materials and one or more concentrated surfactants adsorbed on the surface of the one or more solid adsorbent materials operationally configured as a cleaning agent for wellbore cleaning operations.

In another aspect, the present application is directed to a product including one or more dry free flowing solid treatment particles comprising one or more solid adsorbent materials and one or more concentrated surfactants adsorbed on the surface of the one or more solid adsorbent materials that may be added to spacer fluids and/or slurries as a spacer to promote wellbore cleaning, to promote debris removal from a well, and combinations thereof, prior to cementing the well.

In another aspect, the present application is directed to a slow dissolving polymer stick including one or more dry free flowing solid treatment particles comprising one or more solid adsorbent materials and one or more concentrated surfactants adsorbed on the surface of the one or more solid adsorbent materials for direct injection downhole into a producing well to as a scale inhibitor, a demulsifier, a corrosion inhibitor, a foamer stick, and combinations thereof.

In another aspect, the present application is directed to a product including one or more dry free flowing solid treatment particles comprising one or more solid adsorbent materials and one or more concentrated surfactants adsorbed on the surface of the one or more solid adsorbent materials that may be used as a lubricant or lubricating composition for coil tubing or drilling operations.

In another aspect, the present application is directed to a product including one or more dry free flowing solid treatment particles comprising one or more solid adsorbent materials and one or more concentrated surfactants adsorbed on the surface of the one or more solid adsorbent materials operationally configured as an emulsifier for oil-based drilling fluids, e.g., oil-based mud.

In another aspect, the present application is directed to dry flowable solid treatment particles comprising one or more solid adsorbent materials treated with one or more treatment agents adsorbed on the surface of the one or more solid adsorbent materials, wherein the dry flowable treatment particles exhibit flow characteristics of pre-treated solid adsorbent materials. In other words, the dry flowable solid treatment particles comprise one or more treatment agents in an amount or maximum amount realized just before or as the one or more treatment agents begins to gum or form a paste upon the one or more solid adsorbent materials indicating that the solid material is beyond saturation of the one or more treatment agents, e.g., a maximum amount of one or more concentrated surfactants and/or surfactants.

In another aspect, the present application is directed to a method for treating a well penetrating a subterranean formation, comprising introducing into the well solid treatment particles comprising one or more solid adsorbent materials and one or more surfactants adsorbed on the one or more solid adsorbent materials. Suitable surfactants include, but are not necessarily limited to one or more concentrated surfactants. In one embodiment, suitable concentrated surfactants may include, but are not necessarily limited to dodecyl benzene sulfonic acid salt, benzene sulfonic acid salts, toluene sulfonic acid salts, alkoxylated copolymers,ethoxylated alcohols, terpenes, alkoxylated amines, alkoxylated diamines, alkoxylated triamines, alkoxylated tetra amines, alkoxylated penta amines, alkoxylated alkylphenols, alkoxylated alkylphenol formaldehyde resins, alkoxylated resin esters, alkoxylated bisphenols, alkoxylated bisphenol formaldehyde resins or alkoxylated bisphenol epichlorohydrin resin esters, phosphate esters, alkoxylated phosphate esters, phosphonates, polyacrylamide, acrylic acid acrylamide copolymers, acrylamide acrylamido methyl propane sulfonic acid copolymers, choline choride, quaternary ammonium compounds, amines, polyamines, imidazolines, glutaraldehyde, peracetic acid dibromo nitrilopropionamide, tetrakis hydroxymethyl phosphonium sulfate, and combinations thereof.

In another aspect, the present application is directed to a method for treating a well penetrating a subterranean formation, comprising introducing into the well one or more solid adsorbent materials comprising one or more concentrated surfactants. In one embodiment, suitable concentrated surfactants may include, but are not necessarily limited to dodecyl benzene sulfonic acid salt, benzene sulfonic acid salts, toluene sulfonic acid salts, alkoxylated copolymers, ethoxylated alcohols, terpenes, alkoxylated amines, alkoxylated diamines, alkoxylated triamines, alkoxylated tetra amines, alkoxylated penta amines, alkoxylated alkylphenols, alkoxylated alkylphenol formaldehyde resins, alkoxylated resin esters, alkoxylated bisphenols, alkoxylated bisphenol formaldehyde resins or alkoxylated bisphenol epichlorohydrin resin esters, phosphate esters, alkoxylated phosphate esters, and combinations thereof.

In another aspect, the present application is directed to a method for treating a well penetrating a subterranean formation, comprising introducing into the well free flowing solid treatment particles comprising one or more solid adsorbent materials and one or more concentrated surfactants adsorbed on the one or more solid adsorbent materials, wherein the one or more solid adsorbent materials are selected from the group consisting of low surface area silicas, high surface area amorphous silicas, other high surface area solid adsorbent materials, and combinations thereof.

In another aspect, the present application is directed to a method to enhance hydrocarbon recovery from a subterranean formation, the method comprising (1) providing solid treatment particles comprising one or more solid adsorbent materials and one or more surfactants adsorbed on the one or more solid adsorbent materials; and (2) introducing the solid treatment particles into a penetrating the subterranean formation.

In another aspect, the present application is directed to a dry flowable product for treating a well penetrating a subterranean formation including one or more solid adsorbent materials and one or more surfactants adsorbed on the surface of the one or more solid adsorbent materials.

In another aspect, the present application is directed to a well stimulation fluid comprising free flowing solid treatment particles comprised of surfactants adsorbed on low surface area silicas, high surface area amorphous silicas, other high surface area solid adsorbent materials, and combinations thereof. In one embodiment, the free flowing solid treatment particles may be directed into a well penetrating a subterranean formation during operations including, but not necessarily limited to hydraulic fracturing of a subterranean formation, acidizing well stimulation treatments, and combinations thereof.

In another aspect, the present application is directed to a process for making a solid treatment particle product to be introduced into a well penetrating a subterranean formation, comprising (1) providing a first amount of one or more solid adsorbent materials and a second amount of one or more surfactants; and (2) spraying the one or more solid adsorbent materials with the one or more surfactants producing solid particles comprised of the one or more solid adsorbent materials and the one or more surfactants adsorbed on the one or more solid adsorbent materials.

In another aspect, the present application is directed to a method for introducing one or more surfactants into a well penetrating a subterranean formation, comprising (1) providing solid treatment particles comprising one or more solid adsorbent materials and one or more surfactants adsorbed on the one or more solid adsorbent materials; and (2) introducing the solid treatment particles into the well.

In another aspect, the present application is directed to a method of carrying out one or more subterranean treatments in various aspects of the life cycle of a production well, comprising (1) providing solid treatment particles comprising one or more solid adsorbent materials and one or more surfactants adsorbed on the one or more solid adsorbent materials; and (2) introducing the solid treatment particles into the production well at a desired time during the life cycle of the production well.

In another aspect, the present application is directed to a method of treating a well comprising (1) providing solid treatment particles comprising one or more solid adsorbent materials and one or more surfactants adsorbed on the one or more solid adsorbent materials; (2) introducing the solid treatment particles into the well.

In another aspect, the present application is directed to a method of treating a well which comprises the step of introducing into the well solid treatment particles comprising one or more solid adsorbent materials and one or more surfactants adsorbed on the solid adsorbent materials.

In another aspect, the present application is directed to a method of treating a well which comprises introducing into the well free flowing solid treatment particles comprised of one or more solid adsorbent materials and one or more surfactants operationally configured to release from the treatment particles in a liquid phase.

In another aspect, the present application is directed to a method of treating a well which comprises the step of introducing into the well solid adsorbent materials having one or more treatment agents adsorbed on the solid adsorbent materials.

In another aspect, the present application is directed to a method of stimulating a subterranean formation which comprises the step of introducing into the subterranean formation solid adsorbent substrates having one or more surfactants adsorbed on the solid adsorbent substrates.

In another aspect, the present application is directed to a method of stimulating a subterranean formation which comprises the step of introducing into the subterranean formation solid treatment particles comprised of solid adsorbent substrates and one or more concentrated surfactants adsorbed on the solid adsorbent substrates.

In another aspect, the present application is directed to a method of stimulating a subterranean formation which comprises the step of introducing into the subterranean formation free flowing solid particles including one or more concentrated surfactants adsorbed on the solid adsorbent substrates that are effective to release from the surface of the solid adsorbent substrates when added to an aqueous liquid phase.

As understood by persons of ordinary skill in the art of hydraulic fracturing operations, chemical additives constitute less than two percent by weight of the total fracturing fluid used in a high-volume fracturing operation. As such, a product of this application including one or more dry free flowing solid treatment particles comprised of (1) one or more solid adsorbent materials and (2) one or more concentrated surfactants sprayed onto and adsorbed on the surface of the one or more solid adsorbent materials prior to injection into a well is effective to reduce the total amount of surfactant and the total weight of fracturing fluid otherwise used as part of a high-volume fracturing operation. As an example, a product of this application may include 0.45 kg to 0.91 kg (1.0 pound to 2.0 pounds) of one or more concentrated surfactants that is sprayed on 453.6 kg (1000.0 pounds) of crystalline silica, which provides equivalent or substantially equivalent performance to a liquid form of the same surfactant that is injected into a well at 3.78 liters per 3785.4 liters (1.0 gallon per 1000.0 gallons) of fracturing fluid. A liquid form of the surfactant typically includes a surfactant concentration from 5.0 to 20.0 percent in water or in water plus winterizing agent or mutual solvent and a weight of or about 1000.6 grams per 3.78 liter (8.35 pounds per 1.0 gallon). Also, crystalline silica is typically pumped into a well at 119.8 grams per liter (1.0 pound per gallon) of fracturing fluid. At 8.35 pounds per 1.0 gallon, a surfactant concentration of 5.0 percent equates to or about 0.42 pounds per gallon, i.e., 420.0 pounds per 1000.0 gallons, and a surfactant concentration of 20.0 percent equates to or about 1.67 pounds per gallon, i.e., 1670.0 pounds per 1000.0 gallons. The requirement of only one to two pounds of one or more concentrated surfactants per 1000.0 pounds of crystalline silica of the product for a high-volume fracturing operation is significantly less than the 420.0 pounds to 1670.0 pounds of surfactant used in an equivalent liquid surfactant high-volume fracturing operation—a decrease in surfactant usage from 99.52 percent to 99.94 percent.

The inventor has found that novel free flowing solid treatment particles (the “product”) can be prepared by combining one or more treatment agents, e.g., one or more surfactants, with one or more solid adsorbent materials. Without being limited to theory, in regard to oil and gas well completion and/or well construction and/or production operations, the product of this application eliminates or significantly reduces on-site chemical storage and injection equipment, reduces surfactant chemical costs,reduces transportation costs including transportation costs, reduces the environmental impact at a well-site, reduces the overall total land footprint of a well-site, which simplifies operational logistics, and, by replacing the use of liquid surfactants with the present solid treatment particle product, the need for winterizing liquid surfactants is eliminated.

The relative amounts for the constituents comprising a particular solid treatment particle product can be optimized for one or more particular uses. Moreover, the properties of the solid treatment particles may be modified for specialty applications through the addition of additives and/or altering the manufacturing process for making the product in order to augment the basic characteristics of the solid treatment particles for a given operation. For example, the one or more concentrated surfactants may be operationally configured to release slowly from the surface of the solid adsorbent materials to promote long lasting effects of the surfactant into the surrounding fluid. As discussed below, the solid treatment particles of this invention are ideally suited for, but not necessarily limited to, operations such as oil and gas well stimulation operations, e.g., fracturing, acidizing, and drilling, completion, remedial and/or workover operations.

Solid Adsorbent Materials

A first component of the solid treatment particle product includes a solid adsorbent material (“solid adsorbent” or “solid adsorbent substrate”) effective as a base material or core material of the solid treatment particle product. The individual solid adsorbents used may include, but are not necessarily limited to (1) a low surface area solid material, (2) a high surface area solid material, and combinations thereof, the surface, e.g., interior surface and/or exterior surface, of the solid adsorbents suitably having an affinity for one or more treatment agents, e.g., one or more concentrated liquid surfactants. As such, the solid adsorbents of this application may also be referred to as surfactant adsorbent materials. In one embodiment including solid adsorbents having a low surface area, e.g., a surface area of less than one square meter per gram of solid adsorbents, suitable solid adsorbents may have a minimum adsorption capacity for concentrated surfactant of or about 0.01 percent by weight (0.01 wt %) and a maximum adsorption capacity for concentrated surfactant of or about 0.90 percent by weight (0.90 wt %) of the total weight of a final solid treatment particle. At a minimum, the solid adsorbents of this application have an adsorption capacity effective to produce a solid treatment particle product comprising 0.454 kg-0.907 kg (1.0-2.0 pounds) of surfactant per 453.6 kg (1000.0 pounds) of solid adsorbents.

In addition, the one or more solid adsorbents suitably include a surface area from about 0.001-300.0 m²/g. Without limiting the invention, solid adsorbents for oil and/or gas well completions, well construction and production operations suitably include a particle size sufficiently small that the solid treatment particle produced readily disperses in fluid, e.g., a well stimulation fluid. For such operations, suitable solid adsorbents may include a mesh size from about 5.0 to about 200.0 mesh. Although the amount of concentrated surfactant for a particular solid treatment particle may vary according to the surface area and other parameters as discussed below, a suitable solid adsorbent is operationally configured to produce a solid treatment particle with a ratio of concentrated surfactant to adsorbed solid of from about 1:500 to about 3:1.

The one or more solid adsorbents may be provided in one or more shapes, sizes, crystalline structures, amorphous and other non-crystalline forms. Without limiting the invention, suitable shapes include spherical, egg shaped, cubical, polygonal, amorphous, and combinations thereof. In one implementation, it may be desirable to provide a product comprising one or more solid adsorbents in a uniform or substantially uniform shape, e.g., spherical in shape. in another embodiment, it may be desirable to provide a product comprising one or more solid adsorbents in a uniform or substantially uniform size. In another embodiment, it may be desirable to provide a product comprising one or more solid adsorbents in a plurality of shapes and/or sizes. In addition, the one or more solid adsorbents may be porous, non-porous, and combinations thereof.

In one implementation, the one or more solid adsorbents may include inorganic adsorbent materials including, but not necessarily limited to (1) low surface area silicas such as sand and/or crystalline silica, (2) high surface area amorphous silicas, (3) other high surface area adsorbents, and combinations thereof. Suitable low surface area silicas include, but are not necessarily limited to sand, crystalline silica, and combinations thereof. For purposes of this application, sand is at least about 99.0 percent quartz. Suitable high surface area amorphous silicas include, but are not necessarily limited to Synthetic Amorphous Silica (“SAS”), for example, SAS produced via a thermal route (pyrogenic/fumed) and/or a wet route (precipitated, gel, colloidal) process. Other high surface area adsorbents include, but are not necessarily limited to amorphous alumina oxide, attapulgite clay, zeolites, adsorptive sand, activated carbon, and combinations thereof.

The one or more solid adsorbents may also include other inorganic solid adsorbents including, but not necessarily limited to aeschynite (rare earth yttrium titanium niobium oxide hydroxide), anatase (titanium oxide), bindheimite (lead antimony oxide hydroxide), bixbyite (manganese iron oxide), brookite (titanium oxide), chrysoberyl (beryllium aluminum oxide), columbite (iron manganese niobium tantalum oxide), corundum (aluminum oxide), cuprite (copper oxide), euxenite (rare earth yttrium niobium tantalum titanium oxide), fergusonite (rare earth iron titanium oxide), hausmanmte (manganese oxide), hematite (iron oxide), ilmenite (iron titanium oxide), perovskite (calcium titanium oxide), periclase (magnesium oxide), polycrase (rare earth yttrium titanium niobium tantalum oxide), pseudobrookite (iron titanium oxide), members of the pyrochlore group such as, for example, betatite (rare earths calcium sodium uranium titanium niobium tantalum oxide hydroxide), microlite (calcium sodium tantalum oxide hydroxide fluoride), pyrochlore (sodium calcium niobium oxide hydroxide fluoride), or the like, or a combination comprising at least one of the foregoing pyrochlore group members; ramsdellite (manganese oxide), romanechite (hydrated barium manganese oxide), members of the rutile group, such as, for example, cassiterite (tin oxide), plattnerite (lead oxide), pyrolusite (manganese oxide), rutile (titanium oxide), stishovite (silicon oxide), or the like, or a combination comprising at least one of the foregoing rutile group members; samarskite-(Y) (rare earth yttrium iron titanium oxide), senarmontite (antimony oxide), members of the spinel group such as chromite (iron chromium oxide), franklinite (zinc manganese iron oxide), gahnite (zinc aluminum oxide), magnesiochromite (magnesium chromium oxide), magnetite (iron oxide), and spinel (magnesium aluminum oxide), or the like, or a combination comprising at least one of the foregoing spinel group members; taaffeite (beryllium magnesium aluminum oxide), tantalite (iron manganese tantalum niobium oxide), tapiolite (iron manganese tantalum niobium oxide), uraninite (uranium oxide), valentinite (antimony oxide), zincite (zinc manganese oxide), hydroxides, such as, for example, brucite (magnesium hydroxide), gibbsite (aluminum hydroxide), goethite (iron oxide hydroxide), limonite (hydrated iron oxide hydroxide), manganite (manganese oxide hydroxide), psilomelane (barium manganese oxide hydroxide), romeite (calcium sodium iron manganese antimony titanium oxide hydroxide), stetefeldtite (silver antimony oxide hydroxide), stibiconite (antimony oxide hydroxide), or the like, or a combination comprising at least one of the foregoing inorganic materials.

The one or more solid adsorbents may also include naturally occurring organic adsorbent materials including, but not necessarily limited to crushed bone, nut shells, charcoal, activated carbon, and combinations thereof. The one or more solid adsorbents may also include synthetic organic adsorbent materials including, but not necessarily limited to nylon pellets.

In one embodiment, the solid adsorbents of this application may be used in their naturally occurring size and/or weight and/or shape. In another embodiment, one or more of the solid adsorbents employed may be comminuted to obtain particles of a desired size and/or weight using any suitable technique known in the art including, but not necessarily limited to grinding, jet-milling, ball-milling, wet-milling, and combinations thereof.

Low surface area silicas such as sand and/or crystalline silica and/or high surface area amorphous silicas are widely available commercially. Exemplary commercial sources of such include U.S. Silica Holdings Inc., Frederick, Md., U.S.A.; Preferred Sands, Inc., Radnor, Pa., U.S.A.; PPG Industries, Inc., Pittsburgh, Pa., U.S.A.; Evonik Industries, Parsippany N.J., U.S.A.

Treatment Agents

A second component of the solid treatment particle product includes one or more treatment agents adsorbed on the surface of target solid adsorbents. Suitable treatment agents include, but are not necessarily limited to concentrated surfactants, biocides, antimicrobial agents, iron chelates, demulsifiers, non-emulsifiers, and combinations thereof. The treatment agent(s) may also be referred to herein as the surface active agent of the solid treatment particle as the treatment agent(s) is/are operationally configured to release from the solid adsorbents in a liquid phase in an amount effective to perform one or more particular functions. For purposes of simplicity, the treatment agents are discussed below in terms of one or more concentrated surfactants that are applied to the surface of the target solid adsorbents or mixed in a manner effective to be applied to the surface of the target solid adsorbents in an amount effective to form one or more desired solid treatment particle products operable in a similar manner as liquid surfactants used in oil and gas well operations at the time of this application. As understood by the skilled artisan, the total amount by weight of concentrated surfactant for a particular solid treatment particle product may vary according to the intended use of the concentrated surfactant. As an example, where a solid treatment particle includes one or more concentrated surfactants acting as scale inhibitors, the solid treatment particle suitable includes a total amount of releasable surfactant required to prevent, or at least substantially reduce the degree of, scale formation. As such, in one embodiment the manufacture of one or more solid treatment particles may be controlled via the application of an effective volume of concentrated liquid surfactant to a predetermined amount of solid adsorbents thereby reducing operating costs by minimizing total surfactant usage and reducing or eliminating the presence of any surfactant residue in the product.

In one exemplary embodiment, one or more concentrated liquid surfactants may be adsorbed on the interior surface and/or exterior surface of target solid adsorbents in a non-uniform pattern resulting in solid treatment particles with one or more exposed exterior surfaces of the solid adsorbents. It is also contemplated that one or more solid adsorbents of a product batch not adsorb any concentrated liquid surfactants. In another embodiment, a substantially homogenous blend of solid treatment particles may be realized. As stated above, in suitable operation the one or more surfactants of the solid treatment particle product readily release from their solid adsorbents for dispersal in a liquid phase.

Non-limiting examples of one or more concentrated surfactants include anionic surfactants, cationic surfactants, nonionic surfactants, zwitterionic surfactants, and blends or combinations thereof.

Suitable anionic surfactants include, without limitation, anionic sulfate surfactants, alkyl ether sulfonates, alkylaryl sulfonates, phosphate esters, alkoxylated phosphate esters, or mixture or combinations. Suitable sodium or ammonium alcohol ether sulfate surfactants include those having the general formula R¹O—(CH₂CH₂O)ₙSO₃NH₄, where R¹ is a carbon-containing group including an alkyl group, an aryl group, an alkaryl group, an aralkyl group or mixture thereof. Particularly suitable sodium or ammonium alcohol ether sulfate surfactants include short chain sodium or ammonium alcohol ether sulfate surfactants having between 2 and about 10 carbon atoms, especially, between about 4 and 10 carbon atoms and long chain sodium or ammonium alcohol ether sulfate surfactants having between about 10 to about 24 carbon atoms, more particularly, between about 12 and about 18 carbon atoms, especially, between about 12 and about 14 carbon atoms. The sodium ammonium alcohol ether sulfate surfactants are prepared by reacting 1 to 10 moles of ethylene oxide per mole of alkanol, preferred, are prepared by reacting 3 moles of ethylene oxide per mole of alkanol.

Suitable alkylaryl sulfonates include, without limitation, alkyl benzene sulfonic acids and their salts, dialkylbenzene disulfonic acids and their salts, dialkylbenzene sulfonic acids and their salts, alkyltoluene/alkyl xylene sulfonic acids and their salts, alkylnaphthalene sulfonic acids/condensed alkyl naphthalene sulfonic acids and their salts, alkylphenol sulfonic acids/condensed alkylphenol sulfonic acids and their salts, or mixture or combinations thereof.

Suitable alkyl ether sulfonates include, without limitation, alkyl ether sulfonates having the general formula R²[-(O—R³O)m-(R⁴O)n-(R⁵)]_{y}, where: R²=alkyl, alkenyl, amine, alkylamine, dialkylamine, trialkylamine, aromatic, polyaromatic, cycloalkane, cycloalkene, R³, R⁴=C₂H₄ or C₃H₆ or C₄H₈, R⁴=linear or branched C₇H₁₄SO₃X to C₃₀H₆₀SO₃X when y=1, R⁵=linear or branched C₇H₁₄SO₃X to C₃₀H₆₀SO₃X or H when y>1 but at least one R⁴ must be linear or branched C₇H₁₄SO₃X to C₃₀H₆₀SO₃X, M is greater or equal to 1, n is greater or equal to 0, n+m=1 to 30+, y is greater or equal to 1, X=alkali metal or alkaline earth metal or ammonium or amine.

Suitable cationic surfactants include, without limitation, alkoxylated amines, Gemini, his or di quaternary ammonium surfactants such as his quaternary ammonium halides of bis halogenated ethane, propane, butane or higher halogenated alkanes, e.g., dichloroethane or dibromoethane, or bis halogenated ethers such as dichloroethylether (DCEE). Preferred bis quaternary ammonium halides are prepared from substituted dimethyl tertiary amines, where the substituent includes between about 4 and about 30 carbon atoms, preferably, between about 6 and about 24 carbon atoms, and particularly, between about 8 and about 24 carbon atoms, and where one or more of the carbon atoms can be replace by an oxygen atom in the form of an ether and/or hydroxyl moiety and/or a nitrogen atom is the form of an amido moiety. Particularly preferred his quaternary ammonium halides hydrocarbons are prepared from naturally occurring acids, such as fatty acids, synthetic acids, modified naturally occurring acids, or mixture or combinations thereof. Preferred naturally occurring acids are those found in naturally occurring oils such as coconut oil, palm oil, palm kernel oil, soya, safflower oil, sunflower oil, peanut oil, canola oil, or from animal such as tallow oil and its derivatives. Preferred his quaternary ammonium halides are prepared from disubstituted methyltertiaryamines, where the substituents include between about 4 and about 30 carbon atoms, preferably, between about 6 and about 24 carbon atoms, and particularly, between about 8 and about 24 carbon atoms, and where one or more of the carbon atoms can be replace by an oxygen atom in the form of an ether and/or hydroxyl moiety and/or a nitrogen atom is the form of an amido moiety, such as amidopropyltertiary amines, derived from the reaction of dimethyl aminopropylamine (DMAPA) or similar terminated primary-tertiary diamines, reacted with the above mentioned oils or their corresponding fatty acids, or hydroxy acids. Other preferred cationic surfactants are neutralized dimer acids or anhydrides including alkylsubstituted maleic anhydride, alkylsubstituted diethylmalonic acid, or alkylsubstituted higher dia.cids salts such as azelaic acid (C9), trimer acids as NTA (nitriloacetic acid) sodium or other salts, and aconitic acid and trimetellic anhydride are useful though producting a higher trimer the tertiary amine may be accomplished by reaction of a diamine with a fatty acid or oil, reacting with one amine and then converting the other primary amine to tertiary by the addition of tetra.hydrofuran, ethylene oxide, propylene oxide, butylene oxide, epichlorohydrin, or the like and further where the terminal hydrogen of the primary amine can be alkylated using formaldehyde/formic acid mixtures.

Suitable nonionic surfactants, include, without limitation, alkyl polyglycosides, sorbitan esters, polyglycol esters, methyl glucoside esters, alcohol ethoxylates or alkylphenol ethoxylates, alkylphenol resin alkoxylates, his phenol alkoxylates, resin ester alkoxylates, maleic ester alkoxylates, ester alkoxylates, and mixtures or combinations thereof.

Other examples of suitable anionic surfactants, cationic surfactants, nonionic surfactants, zwitterionic surfactants, and blends thereof are described in U.S. Pat. No. 7,906,474, titled “Alkoxylate Blend Surfactants,” issued on Mar. 15, 2011; U.S. Pat. No. 9,018,145, titled “Foamer Composition and Methods for Making and Using the Same,” issued on Apr. 28, 2015; and U.S. Pat. No. 8,356,667, titled “Liquid Crystals for Drilling, Completion and Product Fluids,” issued on Jan. 22, 2013, each of which is herein incorporated by reference in its entirety.

Suitable fatty acids include, without limitation, lauric acid, oleic acid, stearic acid or the like or mixtures or combinations.

Particularly advantageous treatment agents for manufacture of the product of this application include, but are not necessarily limited to alkoxylated alcohols, alkoxylated alkyl phenols, alkoxylated polymer resins, alkoxylated bis phenols, ethylene oxide polymers, propylene oxide polymers, ethylene oxide/propylene oxide block or random polymers, polyethylene imines, alkoxylated esters, neutralized sulfonates such as alkyl benzene sulfonic acids or naphthalene sulfonic acids, fatty acid derived amides, fatty acid derived quaternary ammonia compounds, alkyl, di-alkyl and tri-alkyl quaternary ammonium compounds, neutralized phosphonates, phosphate esters, glutaraldehyde, tetrakis hydroxymethyl phosphonium sulfate (“THPS”), polyamines, alkyl amine oxides, alkyl amine oxides derived from fatty acids, and combinations thereof.

Manufacture of Solid Treatment Particles

The solid treatment particles are suitably made by combining one or more particular surfactants, e.g., one or more liquid surfactants including, one or more concentrated liquid surfactants, with one or more particular solid adsorbents using one or more manufacturing techniques as described herein. In one particular embodiment, the solid treatment particles may be produced by exposing solid adsorbents to raw concentrated liquid surfactant or a blend of raw concentrated liquid surfactants using one or more spraying systems alone or in addition to one or more mixing systems, blending systems, extruder systems, agitators, shakers, screw conveyors, and combinations thereof.

According to a first methodology, one or more spraying systems may be provided at designated manufacturing location(s) and/or at one or more designated remote locations, e.g., a well site, for production of the solid treatment particles. As such, the one or more spraying systems of this application may be provided as permanent installations or as portable systems. Suitably, a spraying system of this application has one or more spray nozzles effective for delivering one or more streams of concentrated liquid surfactant of one or more particular droplet sizes directly on a particular amount of target solid adsorbents as described below.

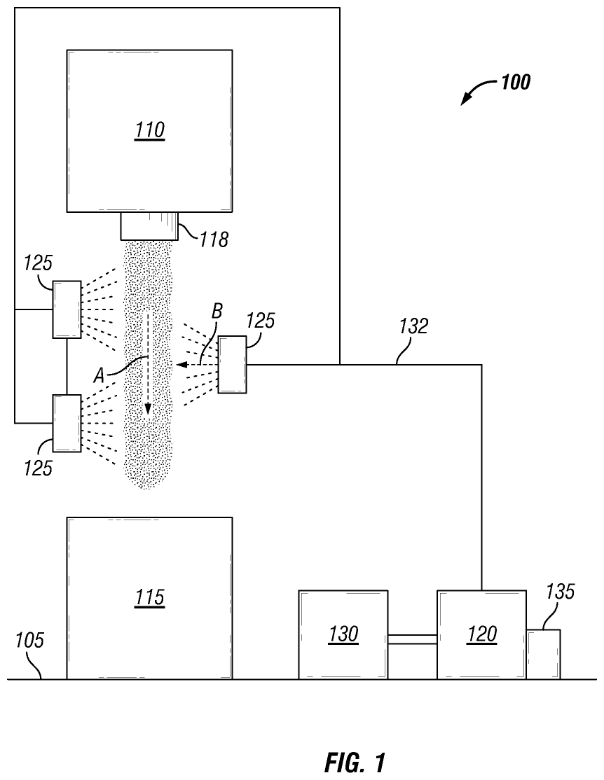

In one non-limiting embodiment as shown in FIG. 1, a first spraying system 100 may be provided on a support surface 105 such as a floor, flatbed trailer or the ground, the spraying system 100 having at least a first container 110 for housing a desired amount of solid adsorbents and a second container 115 operationally configured to receive the solid adsorbents from the first container 110 via gravity flow (see flow of solid adsorbents designated by Arrow A). Accordingly, the first container 110 is located at an elevation greater than the second container 115. The first container 110 may be operationally configured to pivot and dump the solid adsorbents into the second container 115. In the alternative, the first container 110 may include a closeable outlet 118 near or at its bottom for the release of solid adsorbents to the second container 115 via gravity. One non-limiting example of a suitable first container 110 includes a container as described in U.S. Pat. No. 8,585,341, titled “Proppant Discharge System and a Container for Use in such a Proppant Discharge System,” issued Nov. 19, 2013, which is herein incorporated by reference in its entirety.

The spraying system 100 of this embodiment includes a third container 120 for housing a desired volume of concentrated liquid surfactant and one or more spray nozzles 125 in fluid communication with the third container 120. The one or more spray nozzles 125 are located between the first and second containers 110, 115 a desired distance for applying one or more streams (see Arrow B) of concentrated liquid surfactant to the solid adsorbents flowing from the first container 110 into the second container 115. In addition, the distance between the first container 110 and the second container 115 may vary in order to increase or decrease the transfer time of solid adsorbents to the second container 115 thereby altering the time of exposure of solid adsorbents to one or more streams of concentrated liquid surfactant. As shown, the system 100 may include one or more spray nozzles 125 located on one or more sides and at one or more altitudes in relation to a support surface 105 in order to apply a desired volume of concentrated liquid surfactant to the solid adsorbents.

The spraying system 100 also includes a source 130 of pressurized gas (“fourth container 130”) such as air in fluid communication with concentrated liquid surfactant via line 132 and one or more spray nozzles 125 operationally configured to direct the concentrated liquid surfactant through the one or more spray nozzles 125 at a rate effective to break apart the concentrated liquid surfactant into one or more desired spray patterns discussed more below.

The spraying system may also include a heater 135 operationally configured to lower the viscosity of concentrated surfactant housed within the third container 120. A suitable temperature range for reducing the viscosity of the concentrated surfactant ranges from about 40.0° C. to about 60.0° C. (about 104.0° F. to about 140.0° F.). Although one or more dry concentrated surfactants may be added directly to one or more solid adsorbents, e.g., sand, in one particular embodiment, it may be particularly advantageous to achieve a viscosity of the one or more concentrated surfactants of less than 300 mPas (300.0 cp) by applying heat to make the one or more concentrated surfactants easier to spray and to promote maximum coverage of the sand during spraying.

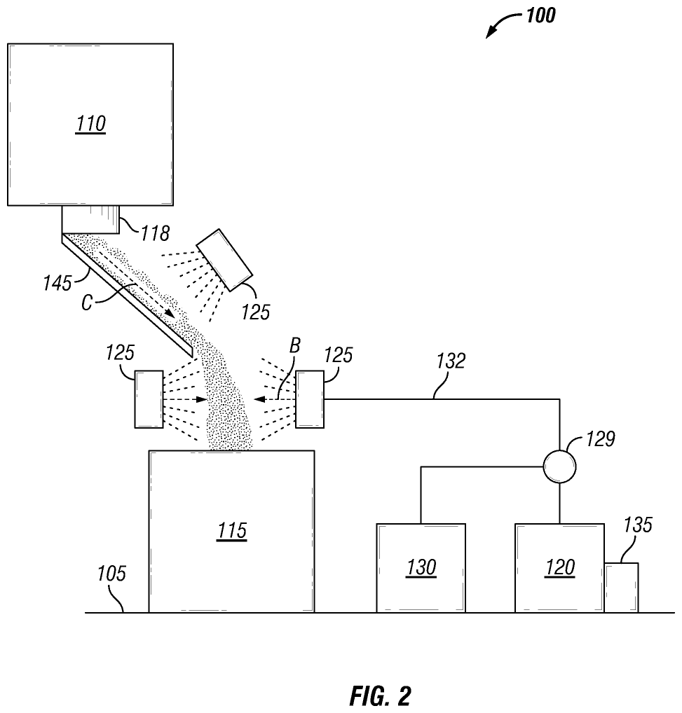

In another embodiment of the system 100 as shown in FIG. 2, concentrated liquid surfactant may be sprayed onto solid adsorbents as the solid adsorbents flow down a chute or slide 145 from the first container 110 to the second container 115 (see Arrow C). A suitable chute or slide 145 may be provided at any angle effective to promote flow of solid adsorbents into the second container 145 via gravity. As such, the second container 115 may be offset from the first container 110. In this embodiment, the system 100 includes an educator 129 whereby the concentrated liquid surfactant may be pulled from third container 120 via the educator 129 using compressed gas from the fourth container 130 as the motive fluid of the system 100.

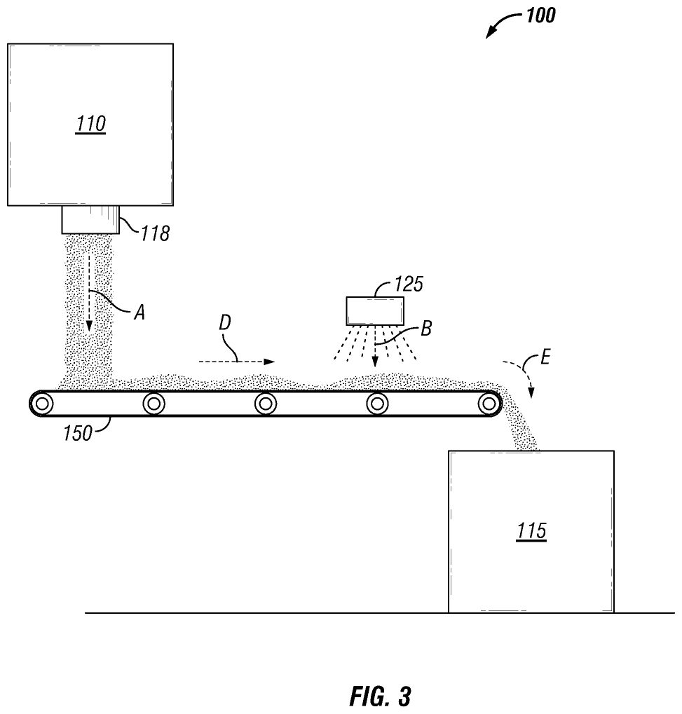

In another embodiment of the system 100 as shown in FIG. 3, a desired amount of solid adsorbents may be directed to a belt conveyor 150 and exposed to one or more spray streams of concentrated liquid surfactant as the solid adsorbents are directed to a second container 115 (see Arrow D and Arrow E).

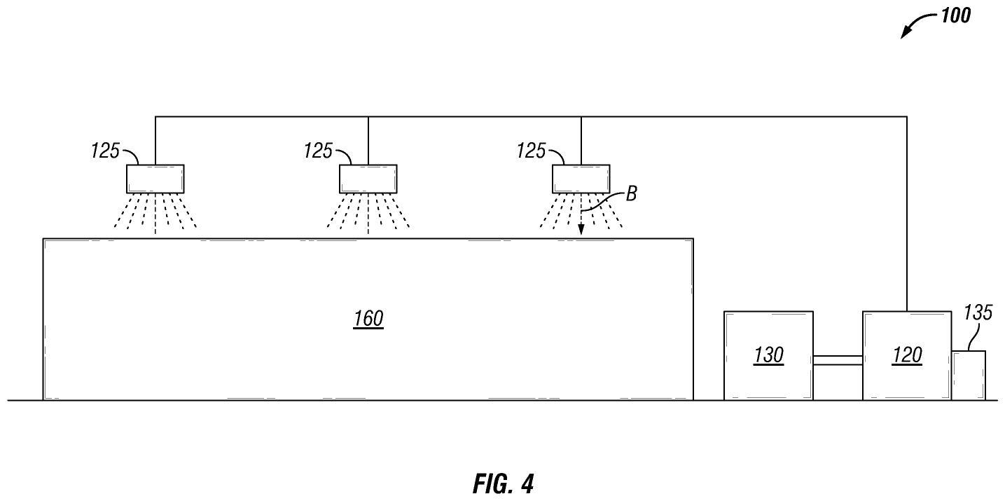

In another embodiment of the system 100 as shown in FIG. 4, concentrated liquid surfactant may be sprayed directly onto non-circulating solid adsorbents housed within one or more containers or vessels 160. In this embodiment, the concentrated liquid surfactant spray (see Arrow B) suitably contacts surface solid adsorbents and thereafter may contact other subsurface solid adsorbents via gravitational flow. In yet another embodiment, concentrated liquid surfactant may be sprayed directly onto solid adsorbents via one or more successive batch additions as may be desired.

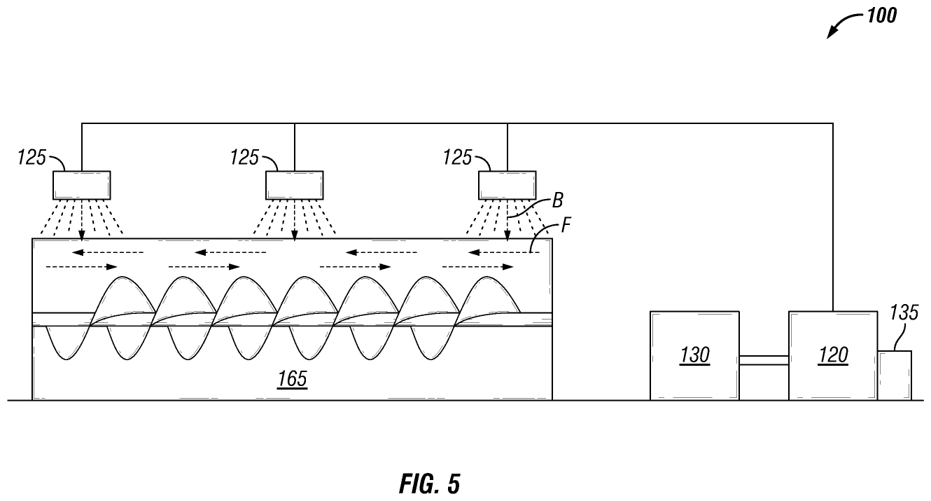

In another embodiment of the system 100 as shown in FIG. 5, an amount of solid adsorbents may be housed within one or more containers or vessels 165 and concentrated liquid surfactant may be sprayed directly onto the solid adsorbents as the solid adsorbents are circulating (see Arrow F) therein. Suitable containers and vessels 165 include, but are not necessarily limited to blenders, extruders, mixers, pug mills, agitator vessels, shakers, screw conveyors, and combinations thereof. One suitable blender includes one or more ribbon blenders. Suitable mixers include one or more paddle mixers and/or double planetary mixers. The rate of circulation and circulation time may vary according to the desired solid treatment particle being produced.

To ensure that a maximum amount of concentrated liquid surfactant is adsorbed onto the solid adsorbents, the solid adsorbents are suitably circulated or otherwise agitated in a manner and duration effective to expose substantially all of the solid adsorbents to one or more spray streams of the concentrated liquid surfactants. Accordingly, a programmable spray system may be employed for the delivery of one or more spray streams of a known volume of concentrated liquid surfactant over a predetermined period of time or time intervals. Optimum spraying time is about five to ten minutes with a mixing time of about five to thirty minutes. As understood by the skilled artisan, the spraying time may be reduced through improved contact of the concentrated liquid surfactant with the solid adsorbents.

In one embodiment, one or more spray nozzles may be held in a fixed position for directing concentrated liquid surfactant onto solid adsorbents. In another embodiment, one or more spray nozzles may be set in motion during spraying operations along one or more predetermined patterns, e.g., reciprocating, circular pattern, etc., in a manner effective to maximize contact between the concentrated surfactant and solid adsorbents. In addition, the spray systems described herein may be operationally configured to minimize spray drift.

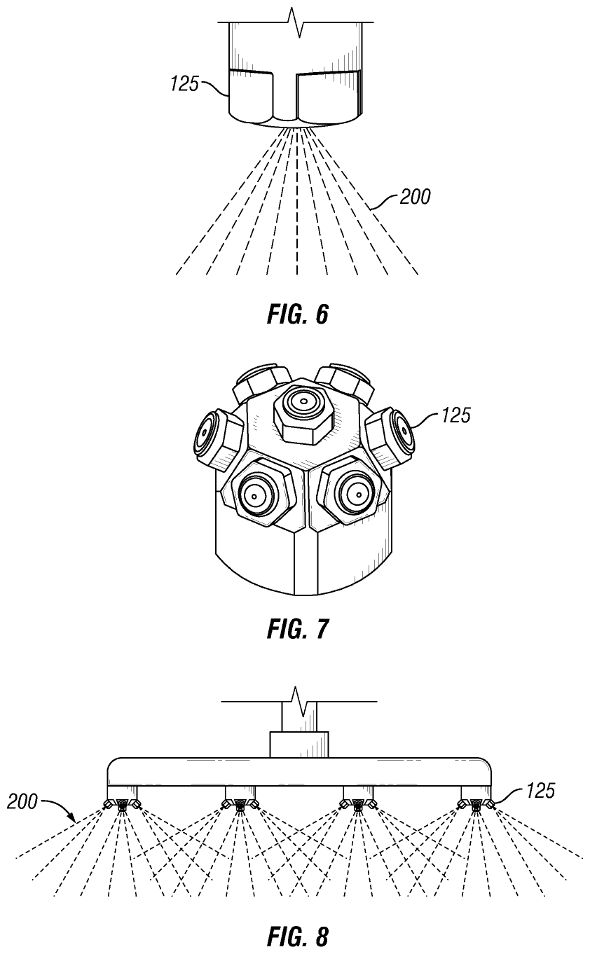

Any spray nozzle operationally configured to break apart a fluid flow of concentrated liquid surfactant into a spray pattern 200 may be employed. Suitable spray nozzles include, but are not necessarily limited to flat fan nozzles, hollow cone nozzles, full cone nozzles, misting nozzles, solid stream nozzles, air atomizing nozzles, hydraulic fine spray nozzles, flat spray nozzles, full cone nozzles, and combinations thereof. In addition, spray nozzles of this application may include single stream tips or multi-stream tips, e.g., three stream tips, five stream tips, seven stream tips, etc. Non-limiting examples of spray nozzles 125 are shown in FIGS. 6-8. In addition, a sprayer system may include two or more spray nozzles providing an overlapping spray pattern of concentrated liquid surfactant onto target solid adsorbents. Suitable spray nozzles are commercially available from Spraying System Co., Wheaton, Ill., U.S.A. having a website of www.spray.com.

Depending on the intended solid treatment particles to be produced, droplet size of the concentrated liquid surfactant may be an important factor when selecting one or more particular spray nozzles for use with one or more embodiments of the system 100 described above. For reference, exemplary droplet sizes according to the American Society of Agricultural and Biological Engineers) S572.1 are provided in Table 1 below.

TABLE 1

| | Volume Median Diameter |
|---|---|
| | (“VMD”) Range |
| Classification | (microns) |
| Extremely Fine | <60 |
| Very Fine | 61-105 |
| Fine | 106-235 |
| Medium | 236-340 |
| Coarse | 341-403 |
| Very Coarse | 404-502 |
| Extremely Coarse | 503-665 |
| Ultra Coarse | >665 |

For comparison purposes, atmospheric fog includes droplets up to about 25.0 microns; a fine atmospheric mist includes droplets ranging from 20.0-100.0 microns; and a fine drizzle of rain includes droplets ranging from 100.0-250.0 microns.

As understood by the skilled artisan, actual spray coverage of the concentrated liquid surfactant may vary according to (1) the size and type of spray nozzle(s) used, (2) the operating pressure, (3) the spray height, (4) spray angle, and (5) nozzle spacing when employing two or more spray nozzles. Theoretical spray coverage at various spray heights is provided below in Table 2.

TABLE 2

| Included | Theoretical Coverage at Various Spray Heights (cm) | | | | | | | |
|---|---|---|---|---|---|---|---|---|
| Spray Angle | 20 cm | 30 cm | 40 cm | 50 cm | 60 cm | 70 cm | 80 cm | 90 cm |
| 15° | 5.3 | 7.9 | 10.5 | 13.2 | 15.8 | 18.4 | 21.1 | 23.7 |
| 20° | 7.1 | 10.6 | 14.1 | 17.6 | 21.2 | 24.7 | 28.2 | 31.7 |
| 25° | 8.9 | 13.3 | 17.7 | 22.2 | 26.6 | 31.0 | 35.5 | 39.9 |
| 30° | 10.7 | 16.1 | 21.4 | 26.8 | 32.2 | 37.5 | 42.9 | 48.2 |
| 35° | 12.6 | 18.9 | 25.2 | 31.5 | 37.8 | 44.1 | 50.5 | 56.8 |
| 40° | 14.6 | 21.8 | 29.1 | 36.4 | 43.7 | 51.0 | 58.2 | 65.5 |
| 45° | 16.6 | 24.9 | 33.1 | 41.4 | 49.7 | 58.0 | 66.3 | 74.6 |
| 50° | 18.7 | 28.0 | 37.3 | 46.6 | 56.0 | 65.3 | 74.6 | 83.9 |
| 55° | 20.8 | 31.2 | 41.7 | 52.1 | 62.5 | 72.9 | 83.3 | 93.7 |
| 60° | 23.1 | 34.6 | 46.2 | 57.7 | 69.3 | 80.8 | 92.4 | 104 |
| 65° | 25.5 | 38.2 | 51.0 | 63.7 | 76.5 | 89.2 | 102 | 115 |
| 73° | 29.6 | 44.4 | 59.2 | 74.0 | 88.8 | 104 | 118 | 133 |
| 80° | 33.6 | 50.4 | 67.1 | 83.9 | 101 | 118 | 134 | 151 |
| 85° | 36.7 | 55.0 | 73.3 | 91.6 | 110 | 128 | 147 | 165 |
| 90° | 40.0 | 60.0 | 80.0 | 100 | 120 | 140 | 160 | 180 |
| 95° | 43.7 | 65.5 | 87.3 | 109 | 131 | 153 | 175 | 196 |
| 100° | 47.7 | 71.5 | 95.3 | 119 | 143 | 167 | 191 | 215 |
| 110° | 57.1 | 85.7 | 114 | 143 | 171 | 200 | 229 | 257 |
| 120° | 69.3 | 104.0 | 139 | 173 | 208 | 243 | | |
| 130° | 85.8 | 129 | 172 | 215 | 257 | | | |
| 140° | 110 | 165 | 220 | 275 | | | | |
| 150° | 149 | 224 | 299 | | | | | |

Accordingly, the number, type and orientation of spray nozzles 125 employed for a particular embodiment of the system 100 may vary according to the size of the manufacturing operation and a desired solid treatment particle composition. Because the system 100 may be built to scale, as the container(s) enlarge to handle greater amounts of solid adsorbents, the total number of spray nozzles 125 used may be increased for maximizing contact between the solid adsorbents and concentrated liquid surfactant in order to produce a consistent solid treatment particle product in larger amounts, or vice versa.

In still another embodiment, it is contemplated that compressed air may be mixed with concentrated liquid surfactant in order to produce finer spray than realized using the concentrated liquid surfactant alone when such is desired. Also, one or more dust control chemicals or nondusting particulate materials may be added to the system 100 as desired, e.g., mixed with the concentrated liquid surfactant.

In still another embodiment, concentrated liquid surfactant may be applied to solid adsorbents via a hand held sprayers, hose, or combinations thereof. Suitable hand held sprayers include squeeze handle type lawn and garden sprayers, pump sprayers having a hand held wand and pump handle of the type often used for dispensing pesticides.

The homogeneity of a particular solid treatment particle product may be determined according to one or more of the following: the type of concentrated liquid surfactant used, the volume of concentrated liquid surfactant used, the viscosity of concentrated liquid surfactant used, the type of solid adsorbents used, the volume of solid adsorbents used, the type of spray system used including the operating pressure, the type(s) of spray nozzles used, the size of droplets of surfactant to be produced, the angle of spray, the spray height, nozzle spacing, the overlapping spray pattern, the consistency of spray, the type of circulating container(s) and/or vessel(s) used, and the duration of operation.

In another implementation, a volume of concentrated liquid surfactant may be fed or poured directly into a blender or mixer and mixed with the solid adsorbents therein to produce a particular solid treatment particle product. In one particular embodiment, a volume of concentrated liquid surfactant may be fed into a blender or mixer and mixed directly with a volume of high surface area amorphous silica and low surface area silica.

In another implementation, solid adsorbents may be conveyed to one or more target storage containers via one or more conduits whereby concentrated liquid surfactant is injected into the conduit for mixing with the solid adsorbents therein or sprayed from nozzles fixed to the upper section or dome of the silos or other storage container.

Once produced, the solid treatment particles may be stored and/or transported via one or more desired storage containers or other container(s) as may be required for a particular operation or according to the laws or regulations of a particular jurisdiction. Without limiting the invention, apposite storage containers may include, but are not necessary limited stationary and/or transportable silos, bins, hoppers, vessels, tanks, drums, boxes, cartons, bottles, rail cars, jugs, sacks, bags, assemblies and combinations thereof. A suitable storage container may be open air and/or sealable. In addition, a suitable portable storage container may include forklift pockets and/or lift eyes for ease of transport. Although performance characteristics of one or more particular surfactants may vary, a shelf life of the product of this application may extend up to about five years. One non-limiting example of a suitable storage container is commercially available from Sandbox Logistics, L.L.C., Houston, Tex., U.S.A.

In another implementation, one or more concentrated surfactants adsorbed on the higher surface area solid adsorbents may be further encapsulated in a slow dissolving polymer stick for direct injection into a producing well to facilitate breaking of oil and water emulsions downhole and at surface.

In another implementation, one or more concentrated surfactants adsorbed on the higher surface area solid adsorbents may be directed into a well penetrating a subterranean formation via a form including, but not necessarily limited to a dissolving polymer tube, a dissolving polymer stick, a soluble bag, and combinations thereof.

In another implementation, one or more concentrated surfactants adsorbed on one or more solid adsorbent materials may be added to fluid and the fluid may then be introduced into a well penetrating a subterranean formation for one or more treatment or treating operations. The fluid may include circulating fluid, spacer fluid, and combinations thereof. The one or more treating operations may include, but are not necessarily limited to cleaning a wellbore of a well, cleaning tubulars of a well, promoting debris removal from a well, and combinations thereof.

The invention will be better understood with reference to the following non-limiting examples, which are illustrative only and not intended to limit the present invention to a particular embodiment.

### EXAMPLE 1

In a first non-limiting example, 400.0 grams of concentrated surfactant comprising 50.0 percent GS 615 (a blend of alkoxylated copolymer and ethoxylated alcohols) and 50.0 percent PD 16N (dodecyl benzene sulfonic acid salt), each commercially available from Gulf Scientific, Inc., Houston, Tex., U.S.A., were blended and heated to 50.0° C. then poured into an agricultural hand spray bottle. 200.0 grams of raw HI-SIL® LPC amorphous silica, commercially available from PPG Industries, Inc., Cleveland, Ohio, was placed in a mixing basin of a laboratory ribbon blender and mixing of the amorphous silica was started at low speed. The concentrated surfactant was then sprayed as a medium fine spray into the top of the ribbon blender creating a steady spray steam while moving the spray bottle side to side. When all surfactant was sprayed onto the amorphous silica, the laboratory ribbon blender was closed and the mixing speed was increased to a mid-range setting. The blend was mixed for forty-five (45) minutes then transferred into a storage container. The resulting product mixture was a 66% concentrated surfactant, 34% silica dry free flowing white solid resembling the raw HI-SIL® LPC amorphous silica but had a surfactant odor and no free surfactant residue in the resulting product mixture.

### EXAMPLE 2

In a second non-limiting example, 300.0 grams of concentrated surfactant made from 35.0% of GS 615, 35.0% PD 16N, and GS X-245 (alkoxylated bis phenol polymer) each commercially available from Gulf Scientific, Inc., Houston, Tex., U.S.A., plus 10.0% of NOVEL® 6-6 Ethoxylate, commercially available from Sasol Corporation, Houston, Tex., U.S.A. was blended and heated to 50.0° C. then poured into an agricultural hand spray bottle. 200.0 grams of raw HI-SIL® LPC amorphous silica was placed in the mixing basin of a laboratory ribbon blender and mixing was started at low speed. The concentrated surfactant was then sprayed into the top of the ribbon blender creating a steady medium spray steam while moving the spray bottle side to side. Once all the surfactant was sprayed onto the HI-SIL® LPC amorphous silica, the laboratory ribbon blender was closed and the speed was increased to a mid-range setting. The blend was mixed for forty-five (45) minutes then transferred into a storage container. The resulting product mixture was a 60.0% concentrated surfactant, 40.0% silica dry free flowing white solid resembling the raw HI-SIL® LPC amorphous silica but had a surfactant odor and no free surfactant residue in the resulting product mixture. It was observed that higher surfactant concentrations on silica resulted in a paste or gum like material being formed during the final stage of mixing in the ribbon blender. The 60.0% surfactant, 40.0% silica was determined to be the highest concentration of surfactant to be economically produced for this blend.

### EXAMPLE 3

In a third non-limiting example, 500.0 grams of 100 mesh frac sand was hand mixed with 1.0 gram of the same concentrated surfactant described in Example 1. Resulting mixture was dry with some small droplets observed of concentrated surfactant and sand in the particle range of 40 mesh mixed throughout the sand.

### EXAMPLE 4

In a fourth non-limiting example, a 500,000.0 barrels (21,000,000.0 gallons) fracturing operation of stimulation fluid includes liquid surfactant usage of 1.0 gallon per thousand gallons (“gpt”), i.e., 21,000.00 gallons of surfactant for a 500,000 barrel fracturing operation. A liquid surfactant comprised of 50.0 percent GS 615 and 50.0 percent PD 16N includes a weight of 1000.6 grams per liter (8.35 pounds per gallon) at a total weight of 79537.4 kg (175,350.00 pounds). The typical liquid surfactant is about 12% active surfactant with water as the only diluent.

At the time of this application, a typical chemical supplier charges $4.50 USD per gallon all-inclusive for field delivery of the liquid surfactant to a well site. In this scenario, the total cost of liquid surfactant is $94,500.00 USD.

The liquid surfactant of the above scenario is replaced with the solid treatment particles product of the present application, for example, 15875.7 kg (35,000.00 pounds) of solid 60% concentrated surfactant on amorphous silica. The solid surfactant used to produce the solid treatment particles product costs $1.95 per pound of surfactant—totaling $68,250.00 USD. The total freight cost to deliver 35,000.00 pounds of product to the well site is $2,000.00 USD for a total cost of $70,250.00 USD. As a result, the product of the present application provides a savings of $24,250.00 USD per fracturing operation—a cost savings of about 25.0 percent.

### EXAMPLE 5

In a fifth non-limiting example, a 85.0 to 100.0 percent active concentrated surfactant product, i.e., a blend of non-ionic and partially anionic surfactants, of the present application is used in place of the liquid surfactant described in Example 4. The concentrated surfactant is heated to 50.0° C. and sprayed directly on 453.6 kg (1,000.0 pounds) of sand. Sand is typically pumped at 119.8 grams per liter (1.0 pound per gallon) of fracturing fluid, e.g., 1,000.00 pounds of sand per 3785.4 liters (1000.0 gallons) of fracturing fluid. As stated in Example, 4, a typical liquid surfactant is about 12% active surfactant. Thus, 0.45 kg (1.0 pound) of the present concentrated surfactant product is equivalent to 3.78 liters (1.0 gallon) of diluted or diluted plus winterized surfactant known in the art. In other words, only 1.0 pound of the concentrated surfactant product is required for every 1000.0 pounds of sand used. The cost comparison of the liquid surfactant described in Example 4 and the solid treatment particles product comprising concentrated surfactant and sand is as follows:

| | |
|---|---|
| The total cost of liquid surfactant: | $94,500.00 USD; |
| Concentrated surfactant cost at $1.85 per pound: | $38,850.00 USD: |
| Estimated cost of spraying at $0.10 per pound: | $2,100.00 USD: |
| Total cost of concentrated surfactant: | $40,950.00 USD per |
| | frac treatment: |
| Savings using the present product: | $53,550 USD per |
| | frac treatment. |

The cost savings is about 57.0 percent.

### EXAMPLE 6

In a sixth non-limiting example, two separate runs of various solid treatment particle products were prepared at different concentrations and the interfacial tension (“IFT”) and surface tension of each product was measured and compared to a baseline comprising zero surfactant and liquid surfactants comprising equivalent surfactant solutions as each of the solid treatment particle products.

Water originating from a frac water pond for hydraulic fracturing operations at the Kissman Unit Oil Lease, Lee County, Tex., U.S.A., was used as the baseline product and for purposes of diluting the other products listed in Table 3 prior to performing interfacial tension and surface tension measurements. interfacial tension and surface tension measurements were performed on both runs of each product using a tensiometer, in particular, a K100 Force Tensiometer commercially available from KRUSS Gmbh, Hamburg, Germany.

The products prepared include the following:
(1) Baseline: a baseline or blank sample of water;
(2) NE 200: the blend of Example 1 including 50.0 percent GS 615 and 50.0 percent PD 16N (where a dilution of 1.0 gpt means the equivalent of 3.78 liters of surfactant per 3785.4 liters (1.0 gallon of surfactant per 1000.0 gallons) of water;
(3) NE 200 Solid: an equal weight blend of GS 615 and PD 16N providing a 100.0 percent active concentrate, which is then mixed with the HI-SIL® amorphous silica (available from PPG Industries, Inc.) at 65.0 percent concentrated surfactant and 35.0 percent silica (where a dilution of 1.33 ppt means the equivalent of 0.60 kg of the NE 200 Solid product in 3785.4 liters (1.33 pounds of the NE 200 Solid product in 1000.0 gallons) of water;
(4) NE 200C: a liquid concentrate made from equal weight proportions of GS 615 and PD 16N;
(5): ME 300 Solution: a surfactant blend comprising TDA 6 (ethoxylated tridecyl alcohol) commercially available from Gulf Scientific, Inc., GS 615, PD 16N, and GS X-245 at 20.0 percent actives in 80.0 percent water;
(6): ME 300 Solid: a 100.0 percent active blend of the ME 300 Solution surfactants with no water added that is sprayed on HI-SIL® amorphous silica at 60.0 percent concentrated surfactant and 40.0 percent amorphous silica (where a dilution of 1.3 gpt means the equivalent of 4.92 liters of surfactant per 3785.4 liters (1.3 gallon of surfactant per 1000.0 gallons) of water;
(7): ME 300C: one hundred percent (100%) active blend of the ME 300 Solution surfactants alone (where a dilution of 0.6 gpt means the equivalent of 2.27 liters of surfactant per 3785.4 liters (0.6 gallon of surfactant per 1000.0 gallons) of water.

TABLE 3

| | IFT, mN/m | | | Surface Tension, mN/m | | |
|---|---|---|---|---|---|---|
| Product | Run 1 | Run 2 | Average | Run 1 | Run 2 | Average |
| (1) Baseline (blank - no surfactants) | 27.96 | 26.78 | 27.37 | 64.38 | 65.00 | 64.69 |
| (2) 1.0 gpt NE 200 solution | 4.36 | | 4.36 | 29.25 | 29.17 | 29.21 |
| (3) 1.33 ppt NE 200 Solid 65.0% | 6.27 | | 6.27 | 28.88 | 28.88 | 28.88 |
| active (1.0 gpt solution equivalent) | | | | | | |
| (4) NE-200C 1000.0 ppm sprayed on | 4.31 | | 4.31 | 27.58 | 27.55 | 27.57 |
| 100 mesh sand (1.0 gpt solution | | | | | | |
| equivalent) | | | | | | |
| (5) 1.3 gpt ME 300 solution | 2.31 | | 2.31 | 29.44 | 29.56 | 29.50 |
| (6) 3.5 ppt ME 300 Solid 65.0% active | 1.55 | | 1.55 | | | |
| (1.3 gpt solution equivent) | | | | | | |
| (7) ME 300C 1000.0 ppm sprayed on | 1.60 | 2.24 | 1.92 | 26.88 | 26.81 | 26.85 |
| 100 mesh sand (0.6 gpt solution | | | | | | |
| equivalent) | | | | | | |

The results of the above runs and measurements demonstrated that the various solid treatment particle products have interfacial tensions and surface tensions substantially similar as the corresponding liquid surfactants alone. Accordingly, no change in operable performance is expected by implementing the solid treatment particle products of this application in place of liquid surfactants.

Although the invention is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed device, system and method, whether or not such embodiments are described and whether or not such features are presented as being a part of a described embodiment. Thus, the breadth and scope of the claimed invention should not be limited by any of the above-described embodiments. Persons of ordinary skill in the art will recognize that many modifications may be made to the present application without departing from the spirit and scope of the invention. The embodiment(s) described herein are meant to be illustrative only and should not be taken as limiting the invention, which is defined in the claims.

I claim:

1. A method for treating a well penetrating a subterranean formation, comprising introducing into the well free flowing solid treatment particles comprising one or more solid adsorbent materials and one or more concentrated surfactants adsorbed on the one or more solid adsorbent materials.

2. The method of claim 1, wherein treating of a well penetrating a subterranean formation includes introducing into the well the free flowing solid treatment particles as cleaners, demulsifiers, non-emulsifiers, microemulsions, friction reducers, flow aids, scale controllers, scale inhibitors, clay stabilizers, biocides, corrosion inhibitors, paraffin inhibitors and combinations thereof.

3. The method of claim 2, wherein treating of a well penetrating a subterranean formation includes introducing into the well free flowing solid treatment particles comprising one or more solid adsorbent materials and one or more concentrated surfactants selected from the group consisting of dodecyl benzene sulfonic acid salt, benzene sulfonic acid salts, toluene sulfonic acid salts, alkoxylated copolymers, ethoxylated alcohols, terpenes, alkoxylated amines, alkoxylated diamines, alkoxylated triamines, alkoxylated tetra amines, alkoxylated penta amines, alkoxylated alkylphenols, alkoxylated alkylphenol formaldehyde resins, alkoxylated resin esters, alkoxylated bisphenols, alkoxylated bisphenol formaldehyde resins or alkoxylated bisphenol epichlorohydrin resin esters, phosphate esters, alkoxylated phosphate esters, phosphonates, polyacrylamide, acrylic acid acrylamide copolymers, acrylamide acrylamido methyl propane sulfonic acid copolymers, choline choride, quaternary ammonium compounds, amines, polyamines, imidazolines, glutaraldehyde, peracetic acid dibromo nitrilopropionamide, tetrakis hydroxymethyl phosphonium sulfate, and combinations thereof.

4. The method of claim 1, wherein the introducing step comprises introducing into the well free flowing solid treatment particles comprising one or more solid adsorbent materials selected from the group consisting of low surface area silicas, high surface area amorphous silicas, other high surface area solid adsorbent materials, and combinations thereof and one or more concentrated surfactants adsorbed on the one or more solid adsorbent materials.

5. The method of claim 1, wherein the introducing step comprises introducing into the well free flowing solid treatment particles comprising one or more solid adsorbent materials selected from the group consisting of frac sand, proppant, and combinations thereof and one or more concentrated surfactants adsorbed on the one or more solid adsorbent materials.

6. The method of claim 1, wherein the introducing step comprises introducing into the well free flowing solid treatment particles comprising one or more solid adsorbent materials each solid adsorbent material having a low surface area of less than one square meter per gram of solid adsorbent materials and having a minimum adsorption capacity for concentrated surfactant of 0.01 percent by weight and a maximum adsorption capacity for concentrated surfactant of 0.9 percent by weight of the total weight of a solid treatment particle.

7. The method of claim 1, wherein the introducing step comprises introducing into the well free flowing solid treatment particles comprising one or more solid adsorbent materials having a surface area of greater than 100.0 square meters per gram of solid adsorbent materials and one or more concentrated surfactants adsorbed on the one or more solid adsorbent materials, wherein the free flowing solid treatment particles comprise about 40.0 percent to 70.0 percent active surfactant.

8. The method of claim 1, wherein the introducing step comprises introducing into the well free flowing solid treatment particles comprising one or more solid adsorbent materials having a mesh size from about 5.0 to about 200.0 mesh and one or more concentrated surfactants adsorbed on the one or more solid adsorbent materials.

9. The method of claim 1, wherein the introducing step comprises introducing into the well free flowing solid treatment particles comprising one or more solid adsorbent materials and one or more concentrated surfactants adsorbed on the one or more solid adsorbent materials, the free flowing solid treatment particles having a ratio of concentrated surfactant to solid adsorbent material from about 1:500 to about 3:1.

10. The method of claim 1, wherein the introducing step comprises introducing into the well free flowing solid treatment particles comprising one or more solid adsorbent materials and one or more concentrated surfactants adsorbed on the one or more solid adsorbent materials, wherein the one or more solid adsorbent materials are selected from the group consisting of sand, crystalline silica, and combinations thereof.

11. The method of claim 1, wherein treating of a well penetrating a subterranean formation includes introducing into the well the free flowing solid treatment particles during operations selected from the group consisting of hydraulic fracturing of the subterranean formation, acidizing well stimulation treatments, and combinations thereof.

12. The method of claim 1, wherein treating of a well penetrating a subterranean formation includes introducing into the well the free flowing solid treatment particles during a gravel pack operation.

13. The method of claim 1, wherein treating of a well penetrating a subterranean formation includes introducing into the well the free flowing solid treatment particles via a form selected from the group consisting of a dissolving polymer tube, a dissolving polymer stick, soluble bag, and combinations thereof.

14. The method of claim 1, wherein treating of a well penetrating a subterranean formation includes introducing into the well fluid comprising the free flowing solid treatment particles, wherein the fluid is selected from the group consisting of circulating fluid, spacer fluid, and combinations thereof and wherein the treating of a well includes treating operations selected from the group consisting of cleaning a well bore of the well, cleaning tubulars of the well, promoting debris removal from the well, and combinations thereof.

15. A method to enhance hydrocarbon recovery from a subterranean formation, the method comprising introducing into the subterranean formation solid treatment particles comprising one or more solid adsorbent materials and one or more surfactants adsorbed on the one or more solid adsorbent materials.

16. The method of claim 15, wherein the introducing step includes introducing into the subterranean formation solid treatment particles comprising (1) one or more solid adsorbent materials selected from the group consisting of low surface area silicas, high surface area amorphous silicas, other high surface area adsorbents, and combinations thereof and (2) one or more surfactants adsorbed on the one or more solid adsorbent materials in a maximum amount.

17. The method of claim 15, wherein the introducing step includes introducing into the subterranean formation solid treatment particles comprising amorphous silica and one or more concentrated surfactants selected from the group consisting of dodecyl benzene sulfonic acid salt, benzene sulfonic acid salts, toluene sulfonic acid salts, alkoxylated copolymers, ethoxylated alcohols, terpenes, alkoxylated amines, alkoxylated diamines, alkoxylated triamines, alkoxylated tetra amines, alkoxylated penta amines, alkoxylated alkylphenols, alkoxylated alkylphenol formaldehyde resins, alkoxylated resin esters, alkoxylated bisphenols, alkoxylated bisphenol formaldehyde resins or alkoxylated bisphenol epichlorohydrin resin esters, phosphate esters, alkoxylated phosphate esters, and combinations thereof.

18. A method for making free flowing solid treatment particles to be mixed with one or more fluids and directed into subterranean formations and used to carry out one or more subterranean treatments in various aspects of a life cycle of oil wells and gas wells, comprising:
providing a first amount of one or more solid adsorbent materials and a second amount of one or more surfactants;
contacting the one or more solid adsorbent materials with the one or more surfactants to produce solid particles comprising the one or more solid adsorbent materials and the one or more surfactants adsorbed on the one or more solid adsorbent materials.

19. The method of claim 18 wherein the providing step includes providing one or more successive batch additions of one or more concentrated liquid surfactants and the contacting step includes contacting the one or more solid adsorbent materials with the one or more concentrated liquid surfactants.

20. The method of claim 18 further including providing a spraying system operationally configured to deliver one or more streams of concentrated liquid surfactants of one or more particular droplet sizes directly onto a particular amount of the one or more solid adsorbent materials.
